(19) United States
(12) Patent Application Publication
(10) Pub. No.: US 2007/0205247 A1
(43) Pub. Date: Sep. 6, 2007

(54) Hammer Tacker

(75) Inventors: Jan Ebbesson, Asenhoga (SE); Bjorn Soderholm, Mullsjo (SE)

Correspondence Address: MILES & STOCKBRIDGE PC, 1751 PINNACLE DRIVE, SUITE 500, MCLEAN, VA, 22102-3833, US

(73) Assignee: ISABERG RAPID AB, Hestra (SE)

(21) Appl. No.: 11/629,708

(22) PCT Filed: Jun. 2, 2005
(86) PCT No.: PCT/SE05/00834

§ 371 Date: Dec. 15, 2006

(30) Foreign Application Priority Data
Jun. 17, 2004 (SE) 0401546-7

(51) Int. Cl. B25C 5/11

(52) U.S. Cl. 227/120

(57) ABSTRACT

A hammer tacker (1), which is used to drive staples (8) into a work piece (7) and which hammer tacker comprises a handle (2) and a magazine (3) which magazine includes a magazine house (4) and a magazine rail (5) which rail is connected to the magazine in such a way that it in its front end (6) can be moved in to and out of (P) the magazine house and in which magazine staples are stored which staples by a feeding device (24) arranged in the magazine are fed to an outlet opening (25) placed in the front end of the magazine and through which outlet opening a fed staple by a driver blade (10) housed in the magazine and arranged to a driver (9) in a driving punch (D) drives the staple into the work piece, wherein the driver (9) is attached to the magazine (3) on the magazines outer side (19).

### TECHNICAL FIELD

The present invention relates to a hammer tacker for driving staples, into a work piece, which hammer tacker comprises a handle and a magazine which magazine includes a magazine house and a magazine rail which rail is connected to the magazine in such manner that it in its front end can be moved in to and out of the magazine house and in which magazine staples are stored which staples by a feeding device arranged in the magazine are fed to an outlet opening placed in the front end of the magazine and through which outlet opening a fed staple by a driver blade housed in the magazine and arranged to a driver in a driving punch drives the staple into the work piece.

### STATE OF THE ART

Hammer tacker of the art said above is commonly known. The problem with this known tacker is that when the driver blade has become worn and needs to be replaced it is complicated to replace the blade since the driver is attached to the inner side of the magazine house. Furthermore, the driver does only comprise one driver blade, which results in a waste of material when a driver blade shall be replaced since the whole driver needs to be replaced when the driver blade has become worn. Thereto it is not possible due to that the driver does only include one driver blade to arrange the driver to include driver blade of different shape, which, could be of advantage when there is a need to change from one staple design to another staple design.

Problem

Consequently, there exists a need to supply a hammer tacker, which comprises a driver, which is easy to replace, and which does not result in a waste of material when one replaces the driver blade, or which has a driver, which includes driver blades of different shapes.

Solution

The present invention overcomes the problem described by means of a hammer tacker described above, which is characterised in that the driver is attached to the magazine on the magazines outer side.

The present invention is further characterised in that the driver comprises a first and a second driver blade.

Thereto is the present invention characterised in that the first and second driver blade is of different design.

Finally is the present invention characterised in that the driver is attached to the magazine by a screw arrangement.

### BRIEF DESCRIPTION OF THE FIGURES

The invention will hereinafter be described with reference to the appended figures, of which:

FIG. 1 is a schematic view of a hammer tacker according to the present invention shown in a driving punch and in a position in which it has come to contact with a work piece;

FIG. 2 is a to FIG. 1 corresponding view in which the hammer tacker is in a position in which a staple has been driven into the work piece;

FIG. 3 is a view in which essential parts of the invention is shown exploded;

FIG. 4 is an enlarged view from line A-A in FIG. 1;

FIG. 5 is a detail view showing the front part of the hammer tacker in which view the driver is omitted and

FIG. 6 shows a driver include in the present invention.

### PREFERRED EMBODIMENT

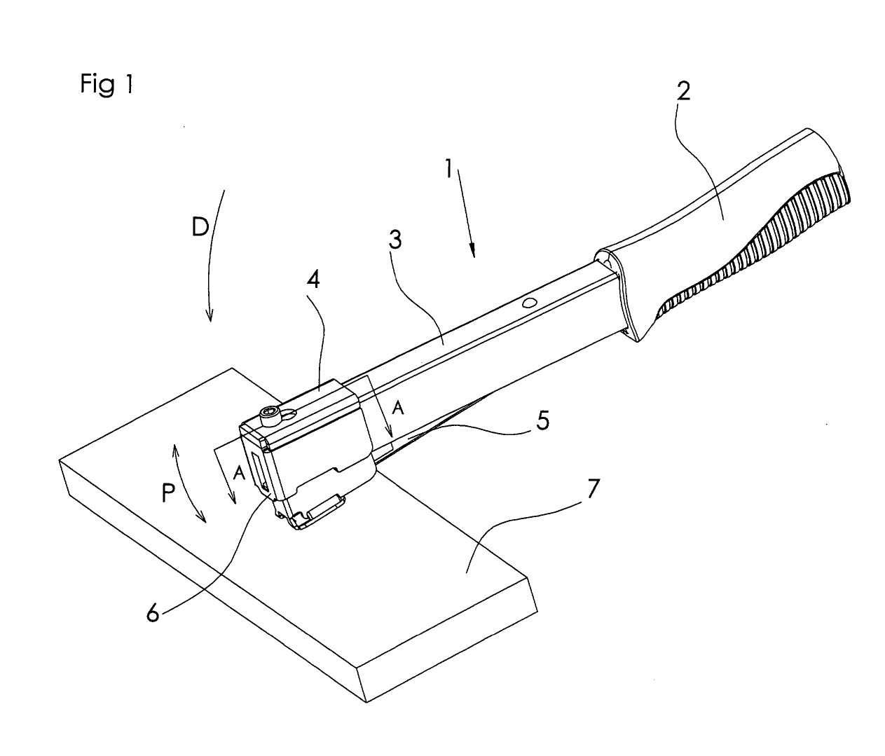

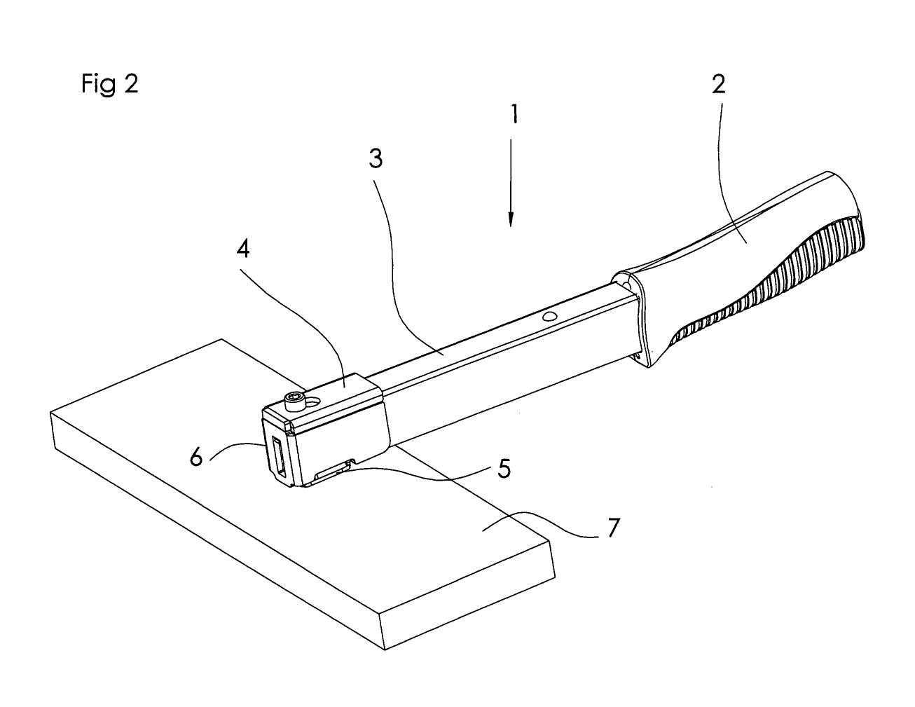

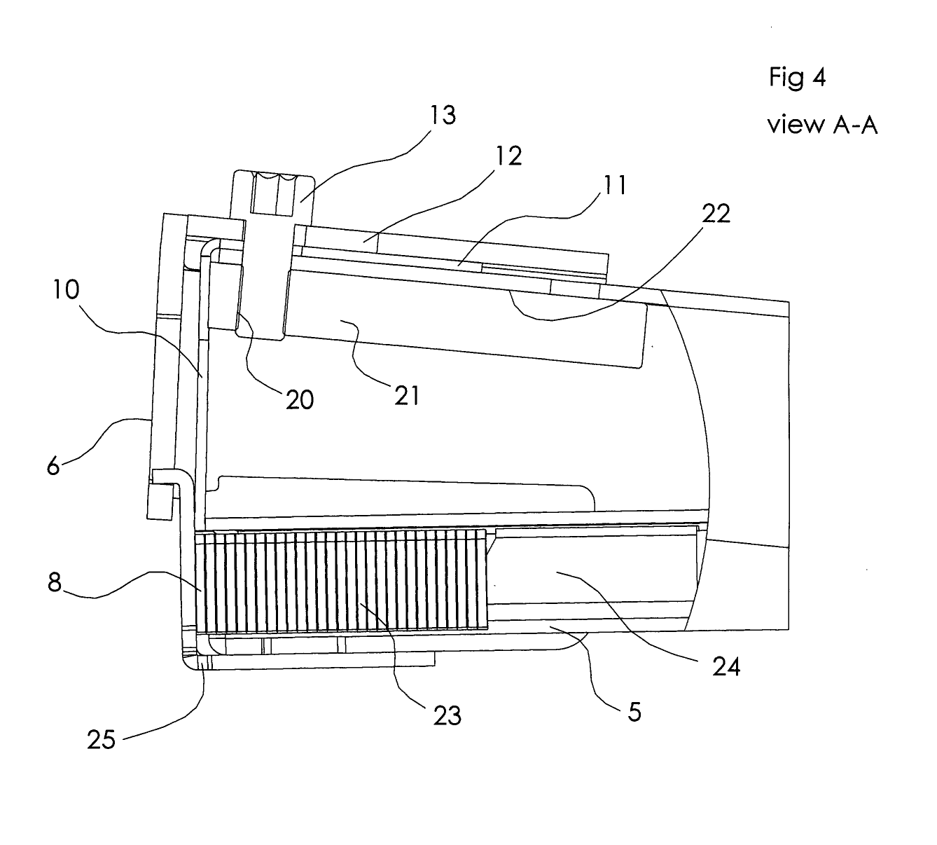

FIG. 1 discloses a hammer tacker 1, which comprises a handle 2 and a magazine 3. The magazine comprises a magazine house 4 and a magazine rail 5. The magazine rail is in known manner pivotally connected to the magazine house, not disclosed in the figure. The connection makes it possible to move the magazine rail in to and out of the magazine house in the front end 6 of the magazine house, which movement is shown by the double arrow P. The figure shows the tacker in a driving punch. The arrow D in FIG. 1 and 2 indicates the direction of the punch. The tacker is in a position in which the rail 5 is in contact with a work piece 7 into which a staple 8, shown in FIG. 4, shall be driven. In the position shown in the FIG. 1 is the rail out of the magazine house. FIG. 2 shows the hammer tacker in a position in which it has been moved further in the direction D and in which position the rail has been moved into the magazine house whereby, as will be described hereafter, a staple is pushed into the work piece.

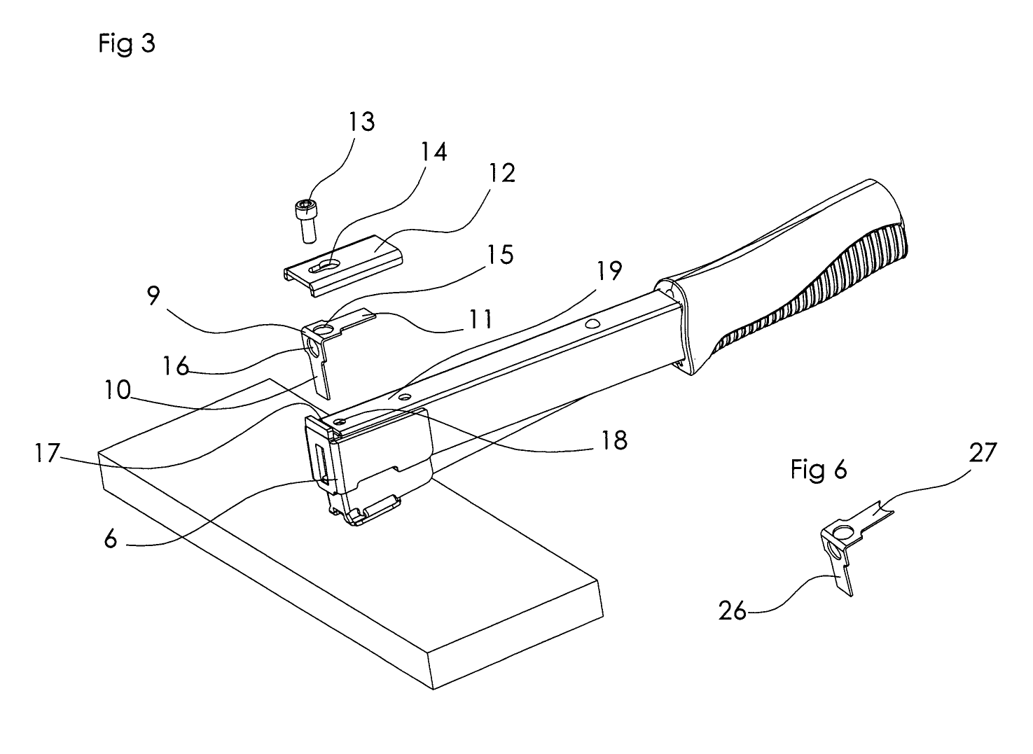

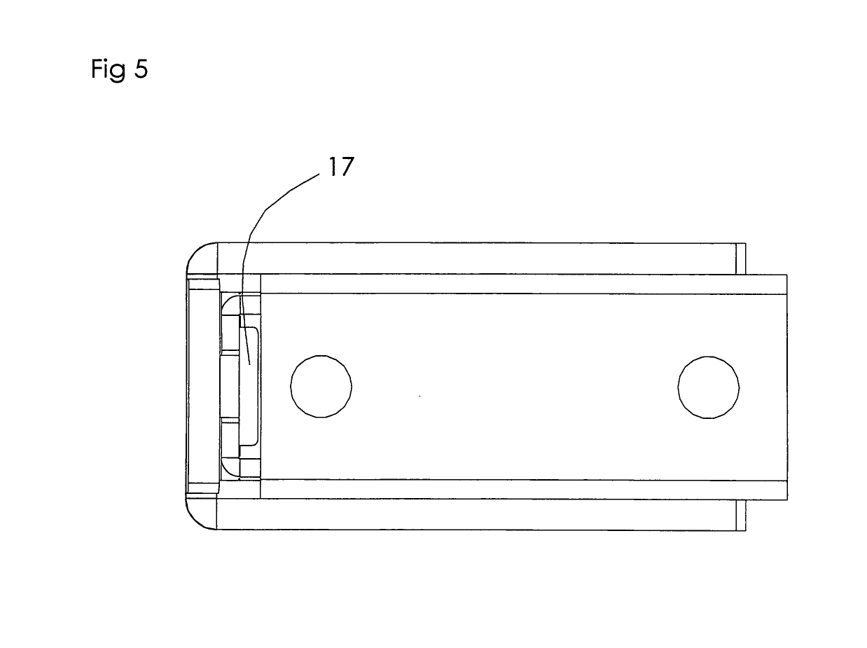

FIG. 3 shows a driver 9 with a first driver blade 10 and a second driver blade 1 1. A washer 12 and a fastening means 13 in the form of a screw are also disclosed. The washer is provided with a first aperture 14 and the driver blade 11 is provide with a second aperture 15 and the driver blade 10 is provided with a third aperture 16. From the figure is also disclosed a slot 17 arranged in the front end of the magazine and a fourth aperture 18. With reference to FIG. 3 and 4 shall the attachment of the driver to the magazine hereinafter be explained. FIG. 4 is a view from line A-A in FIG. 1 and the parts facing the observer has been made transparent. To attach the driver 9 to the magazine the driver blade 10 is moved down into the slot 17, which slot is clearly shown in FIG. 5, to a position in which the driver blade 11 contacts the outer side 19 of the magazine. The washer 12 is thereafter placed on the blade 11 and the screw 13 is placed through the apertures 14,15 and 18 to a tightening engagement with a threaded hole 20 arranged in a block 21 which block is in known manner secured to the inner side 22 of the magazine.

FIG. 4 shows a staple row 23 placed on the rail 5. The row is pushed in the forward direction by a feeding device 24. In the front end of the magazine is an outlet opening 25 arranged and the front staple in the staple row is pushed to that opening. When the hammer tacker in a driving punch moves from the position shown in FIG. 1 to the position shown in FIG. 2 in which position the rail is in the magazine house will the blade 10 hit the front staple 8 and force the staple into the work piece 7.

It is very simple to replace the driver blade if the blade due to use needs to be replaced. To replace the driver blade one unscrew the washer 12 turn around the driver 9 and mount the second driver blade 11 in the same way as described above. This operation is very simple to do since the whole operation is possible to do from the outer side of the magazine.

FIG. 6 discloses a driver which comprises a first driver blade 26 and a second driver blade 27 which driver blade have different design which could be valuable when used staples may have different design.

1. A hammer tacker for driving staples into a work piece which hammer tacker comprises a handle and a magazine which magazine includes a magazine house and a magazine rail which rail is connected to the magazine in such a manner that it in its front end can be moved in to and out of the magazine house and in which magazine staples are stored which staples by a feeding device arranged in the magazine are fed to an outlet opening placed in the front end of the magazine and through which outlet opening a fed staple by a driver blade housed in the magazine and arranged to a driver in a driving punch drives the staple into the work piece, CHARATERISED IN THAT the driver is attached to the magazine on the magazines outer side.

2. A hammer tacker according to claim 1, CHARACTERISED IN THAT the driver comprises a first blade and a second blade.

3. A hammer tacker according to claim 2, CHARACTERISED IN THAT the driver blades are of different shape.

4. A hammer tacker according to claim 1, CHARACTERISED IN THAT the driver is attached to the magazine with a screw arrangement.

5. A hammer tacker according to claim 2, CHARACTERISED IN THAT the driver is attached to the magazine with a screw arrangement.

6. A hammer tacker according to claim 3, CHARACTERISED IN THAT the driver is attached to the magazine with a screw arrangement.
